(19) United States
(12) Patent Application Publication
(10) Pub. No.: US 2016/0357674 A1
(43) Pub. Date: Dec. 8, 2016

(54) Unified Online Cache Monitoring and Optimization

(71) Applicant: Cloud Physics, Inc., Santa Clara, CA (US)

(72) Inventors: Carl A. WALDSPURGER, Palo Alto, CA (US); Irfan AHMAD, Redwood City, CA (US); Alexander GARTHWAITE, South Hamilton, MA (US); Nohhyun PARK, Redwood City, CA (US); Guang YANG, Cupertino, CA (US)

(73) Assignee: Cloud Physics, Inc., Santa Clara, CA (US)

(21) Appl. No.: 15/175,018

(22) Filed: Jun. 6, 2016

Related U.S. Application Data
(60) Provisional application No. 62/172,183, filed on Jun. 7, 2015.

(51) Int. Cl. G06F 12/08

(52) U.S. Cl. CPC G06F 12/0831; G06F 12/0848; G06F 2212/621; G06F 2212/282

(57) ABSTRACT

A cache in a computer system is configured with a plurality of monitoring slices, each comprising a separately addressable partition of the cache. With each monitoring slice is associated a respective sub-range of a hash function, which has a range that includes at least the addressable partitions of the cache that comprise the monitoring slices. For each of a stream of location identifiers submitted by at least one entity, a respective location identifier hash value is computed and used to determine in which, if any, monitoring slice-associated hash function sub-range the location identifier hash value falls. For at least one of the monitoring slices, a frequency value is determined as a function of how many of the location identifier hash values fell into the slice's associated hash function sub-range, and a respective cache utility value is then computed as a function of each monitoring slice's frequency value.

### CROSS REFERENCE TO RELATED APPLICATIONS

This application claims priority of U.S. Provisional Patent No. 62/172,183, filed 7 Jun. 2015.

### BACKGROUND

Caching is a common technique in computer systems to improve performance by enabling retrieval of frequently accessed data from a higher-speed cache instead of having to retrieve it from slower memory and storage devices. For example, caches are commonly included in central processing units (CPUs) to increase processing speed by reducing the time it takes to retrieve information from memory or other storage device locations. As is well known, a CPU cache is a type of memory fabricated as part of the CPU itself. In some architectures such as x86, caches may be configured, hierarchically, with multiple levels (L1, L2, etc.), and separate caches may have different caches for different purposes, such as an instruction cache for executable instruction fetches, a data cache for data fetches, and a Translation Lookaside Buffer (TLB) that aids virtual-to-physical address translation.

Access to cached information is therefore faster—usually much faster—than access to the same information stored in the main memory of the computer, to say nothing of access to information stored in non-solid-state storage devices such as a hard disk. Nonetheless, many systems employ caching at multiple levels. For example, RAM-based caches (such as memcached) are now often used as web caches, and SSD/flash devices are now used in some systems to cache disk data.

Data is typically transferred between memory (or another storage device or system) and cache as cache “lines”, “blocks”, “pages”, etc., whose size may vary from architecture to architecture. Just for the sake of succinctness, all the different types of information that is cached in a given system are referred to commonly here as “data”, even if the “data” comprises instructions, addresses, etc. Transferring blocks of data at a time may mean that some of the cached data will not need to be accessed often enough to provide a benefit from caching, but this is typically more than made up for by the relative efficiency of transferring blocks as opposed to data at many individual memory locations; moreover, because data in adjacent or close-by addresses is very often needed (“spatial locality”), the inefficiency is not as great as randomly distributed addressing would cause.

Regardless of the number, type or structure of the cache(s) included in a given architecture, however, the standard operation is essentially the same: When a system hardware or software component needs to read from a location in storage (main or other memory, a peripheral storage bank, etc.), it first checks to see if a copy of that data is in any cache line(s) that includes an entry that is tagged with a corresponding location identifier, such as a memory address. If it is (a cache “hit”), then there is no need to expend relatively large numbers of processing cycles to fetch the information from storage; rather, the processor may read the identical data faster—typically much faster—from the cache. If the requested read location's data is not currently cached (a cache “miss”), or the corresponding cached entry is marked as invalid, however, then the data must be fetched from storage, whereupon it may also be cached as a new entry for subsequent retrieval from the cache.

In most systems, the cache will populate quickly. Whenever a new entry must be created, for example because the cache has a fixed or current maximum size and has been filled, some other entry must therefore be evicted to make room for it. There are, accordingly, many known cache “replacement policies” that attempt to minimize the performance loss that each replacement causes. Many of these policies rely on heuristics that use access recency and/or access frequency to implement different types of predictions about which cache entries are least likely to be used, and are therefore most suitable for eviction. For example, a least-recently-used (LRU) heuristic evicts the entry with the oldest last-access time, a least-frequently-used (LFU) heuristic evicts the entry with the smallest access count, and more sophisticated policies such as LIRS and ARC use adaptive policies that incorporate both recency and frequency information.

The greatest performance advantage, at least in terms of speed, would of course occur if the cache (to include, depending on the system, any hierarchical levels) were large enough to hold the entire contents of memory (and/or disk, etc.), or at least the portion one wants to use the cache for, since then cache misses would rarely if ever occur. In systems where the contents of the hard disk are cached as well, to be able to cache everything would require a generally unrealistic cache size. Moreover, since far from all memory locations are accessed often enough that caching them gives a performance advantage, to implement such a large cache would be inefficient. Such theoretical possibilities aside, a processor cache will typically be much smaller than memory, and a memory cache will be much smaller than a hard disk.

On the other hand, if the cache is too small to contain the frequently accessed memory or other storage locations, then performance will suffer from the increase in cache misses. In extreme cases, having a cache that is far too small may cause more overhead than whatever performance advantage it provides, for a net loss of performance.

The cache is therefore a limited resource that should be managed properly to maximize the performance advantage it can provide. This becomes increasingly important as the number of software entities that a CPU (regardless of the number of cores) or multiprocessor system must support increases. One common example would be many applications loaded and running at the same time—the more that are running, the more pressure there is likely to be on the cache. Of course, some software entities can be much more complicated than others, such as a group of virtual machines (VMs) running on a system-level hypervisor, all sharing the same cache.

There are, accordingly, many existing and proposed systems that attempt to optimize, in some sense, the allocation of cache space among several entities that might benefit from it. Note the word “might”: Even if an entity were exclusively allocated the entire cache, this does not ensure a great improvement in performance even for that entity, since the performance improvement is a function of how often there are cache hits, not of available cache space alone. In other words, generous cache allocation to an entity that addresses memory in such a way that there is a high proportion of misses and therefore underutilizes the cache may be far from efficient and cause other entities to lose out on performance improvements unnecessarily. Key to optimizing cache allocation—especially in a dynamic computing environment—is the ability to determine the relative frequencies of cache hits and misses.

FIG. 1 illustrates qualitatively a typical “miss ratio curve” (MRC) which is often used to represent cache performance. By convention, an MRC is plotted with the cache size on the X-axis, and the cache miss ratio (i.e., misses/(hits+misses)) on the Y-axis. In the region marked “A” in FIG. 1, the cache is so small that it has a high percentage of misses; in this region, the performance loss of handling cache misses could even outweigh any gains achieved for the relatively few cache hits. In the region marked “C”, however, the cache is so large that even an increase in its size will bring negligible reduction in cache misses—the cache effectively includes the entire memory region that is ever addressed. In most implementations, at any given moment of execution, the preferred choice in the trade-off between performance and cache size will normally lie somewhere in the region marked “B”.

As FIG. 2 shows, in many real-world cases, the transition from region A to region C is not as gradual as FIG. 1 illustrates, but rather may be “steep”, indicating an abrupt drop in the miss rate as the cache size increases above some point.

A miss ratio curve (MRC) thus summarizes the effectiveness of caching for a given workload. A human administrator or an automated program can then use MRC data to optimize the allocation of cache space to workloads in order to achieve aggregate performance goals, or to perform cost-benefit tradeoffs related to the performance of competing workloads of varying importance. Note that in some cases, a workload will not be a good caching candidate, such that it may be more efficient simply to bypass the caching operations for its memory/storage accesses. The issue then becomes how to construct the MRC.

Given that a memory access will lead to either a hit or a miss, note that, instead of working with miss ratios (and miss rate curves), the system may work equally well with hit ratios (and thus hit rate curves). In other words, the system may compute and base decisions on either type of access result ratio, either an access success ratio (a hit ratio) or an access failure ratio (a miss ratio). Furthermore, instead of using miss/hit ratios, a system may use miss/hit rates just as well. The resulting curves, of either type (miss/hit) or metric (ratio/rate), are referred to herein collectively as a “cache utility curve” (CUC). Although the discussion below will focus on miss ratios, it is therefore equally applicable, with easily understood adjustments, to hit ratios, and similar adjustments may be used to enable analysis and operation with miss/hit rates as well.

It would be far too costly in terms of processing cycles to re-evaluate an MRC upon every access request (to conventional memory, SSD/flash devices, to other storage devices such as disks, etc.). Especially in a highly dynamic computing environment with many different entities vying for maximum performance, exhaustive testing could take much longer than the performance advantage the cache itself provides. Different forms of sampling or other heuristics are therefore usually implemented. For example, using temporal sampling, one could check for a hit or miss every n microseconds or processing cycles, or at random times. Using spatial sampling, some deterministically or randomly determined subset of the addressable memory space is traced and checked for cache hits and misses. Sampling may also be based on a function of the accesses, such as every N references, or some other function of logical time. Sampling may also be based on any property of access requests, including characteristics such as the size of accesses, whether accesses are reads or writes, and the context that initiated the request.

Spatial sampling has been proposed in the prior art to reduce the cost of MRC construction, essentially running the known Mattson Stack Algorithm over the subset of references that access sampled locations. For example, according to the method disclosed in U.S. Pat. Nos. 8,694,728 and 9,223,722 (Waldspurger, et al., “Efficient Online Construction of Miss Rate Curves”), a set of pages is selected randomly within a fixed-size main-memory region to generate MRCs for guest-physical memory associated with virtual machines. Earlier computer architecture research by Qureshi and Patt on utility-based cache partitioning (Qureshi, et al., “Utility-Based Cache Partitioning: A Low-Overhead, High-Performance, Runtime Mechanism to Partition Shared Caches”, in Proceedings of the 39th Annual IEEE/ACM International Symposium on Microarchitecture (MICRO 39), December 2006) proposed adding novel hardware to processor caches, in order to sample memory accesses to a subset of cache indices. In U.S. Pat. No. 9,336,141 as well as U.S. patent application Ser. Nos. 14/315,678, and 15/004,877 one or more of the present inventors have disclosed methods for the efficient online construction of cache utility curves using hash-based spatial sampling.

In the context of shared last-level caches for multi-core processors, a separate approach, also using spatial hashing, has recently been proposed for optimizing cache performance in a system called Talus (see Beckman, Nathan, et al “Talus: A Simple Way to Remove Cliffs in Cache Performance”, Proceedings of the 21st IEEE International Symposium on High Performance Computer Architecture (HPCA '15), San Francisco Bay Area, Calif., February 2015). Talus divides the cache into two shadow partitions (“main slices”) and controls the portion of requests served by each partition using spatial hashing. The two different partitions each preferably service different percentages of the inputs, that is, cache accesses. For its cache optimization procedure Talus takes a cache miss curve as input, and uses this curve to allocate both cache space and a fraction of the input address space to each shadow partition. Talus then attempts to optimize cache performance by operating at an efficient point along a convex hull of the miss curve.

Hardware-based techniques, such as Qureshi's UMON-DSS, have been developed to construct miss curves for processor caches that employ an LRU replacement algorithm. However, there are no known efficient techniques for more general replacement policies that are not stack algorithms. Indeed, the Talus paper explicitly notes that with known techniques, monitoring is generally impractical for policies outside the LRU family. The authors suggest further development of high-performance cache replacement policies for which miss curves can be obtained cheaply (see Beckman, cited above).

Clearly, it would be preferable to avoid needing to redesign caching algorithms just to support such monitoring. Thus, a method for performing efficient online construction of miss curves for non-LRU algorithms is highly desirable. Ideally, miss-curve construction would be able to be integrated with the cache optimization method in a unified manner. This would enable more general Talus-like performance optimizations for sophisticated caching algorithms. For example, the Adaptive Replacement Cache (ARC) and CLOCK-Pro caching policies are known to outperform LRU significantly for many workloads, and have been used in modern software-managed caches for block I/O storage systems.

### BRIEF DESCRIPTION OF THE DRAWINGS

FIGS. 1 and 2 show the general properties of a Cache Utility Curve, in particular, of a Miss Ratio Curve.

FIG. 3 illustrates the main hardware and software components of an embodiment of a system in which cache analysis is unified with cache control.

FIG. 4 illustrates how statistics compiled for different cache monitoring slices are converted for presentation as points on a cache utility curve.

### DETAILED DESCRIPTION

Disclosed here is a general, unified method for both monitoring and optimizing the performance of a cache by partitioning its capacity into several “slices” using spatial hashing. This technique adapts to workload behavior automatically, and, significantly, is independent of the particular policy or replacement algorithm used by the cache. Each monitoring slice is responsible for caching data in a partition associated with a different subset of the input address space. The address-to-slice mapping is determined using a hash function, and associating a subset of the hash value space (such as a contiguous range) with each slice. The technique may also be used with any set of mutually exclusive caches, which need not be hierarchical.

The description of embodiments here focuses primarily on software-managed caches for storage systems, but the same basic approach can be applied more generally to a wide range of caching systems, from hardware implementations of processor caches to web-based object caching systems such as memcached.

### Shards

The Spatially Hashed Approximate Reuse Distance Sampling (“SHARDS”) method disclosed in U.S. patent application Ser. No. 15/004,877 (Waldspurger, et al.), which is incorporated herein by reference, employs randomized spatial sampling, implemented by tracking only references to representative locations in a simulated cache, selected dynamically based on a function of their hash values.

According to the SHARDS method, for each location L that a workload addresses, the decision of whether or not to sample L is based on whether hash(L) satisfies at least one condition. For example, the condition hash(L) mod 100<K samples approximately K percent of the entire location space. Assuming a reasonable hash function, this effectively implements uniform random spatial sampling. The “location” L, both in SHARDS and in this invention, may be a location such as an address, or block number, or any other identifier used to designate a corresponding portion of system memory, or disk storage, or some other I/O device (for example, onboard memory of a video card, or an address to a data buffer, etc.), or any other form of device, physical or virtual, whose identifier is used to create cache entries. The only assumption is that there is some form of location identifier L that may also be used to identify a corresponding cache entry if the data at L is in fact cached.

Merely for the sake of simplicity, the various examples described below may refer to “memory”; these examples would also apply to other storage devices, however, including disks, volatile or non-volatile storage resident within I/O devices, including peripheral banks of solid-state or other storage media, etc. As before, “data” is also used here to indicate any form of stored digital information, “pure” data as well as instructions, etc.

SHARDS provides a family of techniques that employ hash-based spatial sampling to construct an MRC for a single workload efficiently. One method works for cache policies that are stack algorithms, such as LRU replacement. This approach uses sampling with a standard reuse-distance algorithm to construct a complete cache utility curve (such as an MRC) at all cache sizes in a single pass. Another more general method works with any cache policy, including non-stack algorithms such as ARC or CLOCK-Pro. This approach uses sampling with a scaled-down cache simulation (also known as a “microcosm” simulation), where the full caching algorithm is run over the sampled input with a smaller cache size that is also scaled down by a similar factor as the input. This method computes cache utility (such as a miss ratio) at a single cache size, so multiple scaled-down simulations are performed at different cache sizes, yielding discrete points along the full cache utility curve. In this application, references to the “SHARDS” method refer to this entire family of techniques, which include both single-pass reuse-distance methods and scaled-down simulation methods.

In some embodiments and implementations of the SHARDS method, the concept of “location” may be generalized to include not only addresses, but may also be based on hashes of content. Thus, “spatial” as in “spatial hashing” or “spatial sampling” may refer more generally to the domain of keys, other notions of logical space, etc., and not necessarily to physical space. A location identifier such as a lookup key may thus be anything used to identify a value, including a content-hash, a universally unique identifier (UUID), etc. Constructing an MRC using content-hashing, such as in systems that have content-addressable stores (CAS), instead of address-hashing as the basis for “location” may, for example, yield an MRC more efficiently for some storage caches that perform deduplication for cached blocks. Embodiments of this invention are not restricted to any particular notion of address space.

In addition to using spatial sampling just for constructing an MRC, the SHARDS technique may inform other decisions as well. For example, some storage caches use compression to increase the amount of data that can be cached. The SHARDS method may in such cases be used to process only a small fraction of the actual cache requests using spatial sampling, in order to yield a good statistical estimate of the improvement that would be achieved by using compression. This could in turn inform administrative decisions about whether or not to enable such a feature. A variant of this idea would be to use different compression techniques on separate portions of the cache and choose the best overall approach from what is measured.

### Slices

The novel method disclosed here extends some of the novel concepts of the SHARDS technique to enable “intra-workload” MRC construction, and may operate on “live” data, that is, actual cache accesses, as opposed to a simulation. To accomplish this, embodiments measure and generate miss ratio (or other CUC) data for a plurality of actual cache partitions, referred to herein as “monitoring slices”.

Embodiments of this invention provide an efficient solution to the problem of online utility curve construction by introducing multiple “monitoring slices”, which may (but need not) be used in conjunction with shadow partitioning such as is found in the Talus system. In various embodiments, main slices such as are found in a Talus system are used both for control and for monitoring, in addition to the specially configured monitoring slices. The cache utility data made available by the monitoring slices (with or without also using the main slices for monitoring too) may then be returned to the cache management system to inform cache optimization. The monitoring slices may be chosen to be different in number and/or have a spatial layout different from whatever partitioning may be in use for cache allocation optimization. Indeed, no Talus-like shadow partitioning at all is required to implement monitoring slices according to embodiments of this invention, although the invention may be used advantageously to inform cache allocation decisions even in real time, including in systems that use shadow partitioning. Each monitoring slice acts like a scaled-down simulation, and the set of miss ratios associated with the monitoring slices define the miss curve at discrete cache allocation points.

Unlike in the systems disclosed in U.S. Pat. No. 9,336,141 as well as U.S. patent application Ser. Nos. 14/315,678, and 15/004,877, in which a scaled-down simulation is distinct from the actual cache, the monitoring slices are preferably integrated with the cache itself, and process actual cache requests. Nonetheless, although embodiments of the invention may operate directly with partitions of the actual, physical cache, it would also be possible to apply the methods described herein to enable scaled-down simulations of simulated caches as well. Like scaled-down simulation, each slice also collects performance metrics, such as hit and miss counts. The hit and miss counts for a single monitoring slice may then be used to determine one point on a CUC (for example, a miss rate curve), corresponding to the slice's emulated cache size, which is equal to its actual partition size divided by the fraction of the input address space that it handles. Multiple monitoring slices may then be employed to provide an approximation to the desired CUC consisting of many discrete points. Merely for the sake of illustration, embodiments are described below for generating a miss ratio curve (MRC). It should be understood, however, that the techniques described may be used to construct other types of cache utility curves as well, such as hit ratio curves, or curves based on rates instead of ratios.

By using many small monitoring slices S₁ . . . S_{K}, a discretized MRC, consisting of the miss ratios for K different emulated cache sizes, is available to inform the optimization method. Each monitoring slice is a partition Sᵢ that contains Nᵢ blocks, and handles requests for a fraction Fᵢ of the input address space. Running counts of hits Hᵢ and misses Mᵢ are maintained for each monitoring slice Sᵢ. As a result, each monitoring slice Sᵢ yields a point on the miss ratio curve at an emulated cache size Eᵢ=Nᵢ/Fᵢ, with measured miss ratio Mᵢ/(Mᵢ+Hᵢ). Note that the emulated size of a monitoring slice can be controlled by varying either (or both) of Nᵢ and Fᵢ. In the typical and preferred case, the sum of the sizes of the monitoring slices may be small relative to the main slices. It would also be possible to dynamically change even the number of monitoring slices.

As an illustrative example, consider a storage I/O cache with an aggregate capacity of 32 GB, capable of storing approximately two million blocks of data with a 16 KB block size. Suppose that K=20 cache sizes are desired to construct an online MRC for a typical input workload, uniformly spaced (any desired spacing may be used in actual implementations) between 4 GB and 124 GB at 6 GB intervals. Suppose further that a monitoring slice containing 1K blocks provides sufficient accuracy for computing a useful approximate miss ratio. With Nᵢ=1024 for each slice Sᵢ, a single monitoring slice consumes 16 MB. Decreasing Fᵢ values may then used to emulate increasingly large cache sizes. For example, since E₁=4 GB, and E₃=16 GB, one may set F₃=F₁/4, in order to emulate a cache size for S₃ that is four times larger than S₁.

Thus, in this example, the aggregate total across all 20 monitoring slices would be 320 MB, or about 1% of the total 32 GB cache capacity. The other 99% of the cache space may be allocated to any main slices established for the purposes of allocation, such as in a Talus-like arrangement. Alternative implementations may use different numbers of monitoring slices and allocate non-uniform numbers of blocks to different slices. Different implementations may also use non-linear spacing between monitored cache sizes, such as powers of two, in order to span a large range of emulated cache sizes with fewer points. Alternatively, implementations may cluster the range of caches sizes around the current allocation in cases where the sizes of the main slices will be changed incrementally. Performance metrics from each main slice may also be used to determine additional points on the miss curve, augmenting the values obtained from the monitoring slices. In some implementations, more than two main slices may be used.

Other embodiments may employ monitoring slices using different caching algorithms or replacement policies, such as LRU, ARC, and CLOCK-Pro. In this case, several monitoring slices may have the same emulated cache size, but use different caching algorithms. This allows the most effective caching algorithm for a given workload to be discovered dynamically, and used in the main slices. The “best” algorithm may then be re-evaluated periodically, allowing the caching algorithm to adapt to a changing workload. Yet another variant is to allow different caching algorithms to be employed in different main slices. The resulting overall cache behavior will operate at an efficient point on the convex hull formed by the superposition of the per-algorithm MRCs.

Although embodiments of this invention do not in any way presuppose or require a Talus-like arrangement, some embodiments may be used to advantage in conjunction with a system that incorporates Talus, for example, by employing monitoring slices to estimate the behavior of Talus' two main slices were they to be sized in different ratios above and below the current configuration. These monitoring slices may then be used to detect when the current configuration becomes less efficient, possibly signaling a change in access patterns.

The Talus system can be used to improve the results of multi-workload partitioning by effectively making the MRC for each workload convex. In some embodiments of the invention, this notion may be extended to partitioning subsets of the requests from within a single workload, rather than between workloads; moreover, partitioning may be done both ways, that is, both within a workload and between workloads. The requests from a single workload may in this case be logically segregated into separate sets of requests for which online MRCs are created using the monitoring slices provided by this invention. Examples include segregation of requests based on the size of accesses, the compressibility of accessed data, whether accesses are reads or writes, the sequentiality of requests, and the accessed addresses, such as ranges of Logical Block Numbers (LBNs). For each set of requests, Talus (with unified monitoring according to this invention) may be used to operate the cache for that set of requests at an efficient point along the convex hull of its MRC. Any known partitioning method may then be used across the request sets.

In the special case where the cache happens to use a replacement policy that is a stack algorithm, such as LRU, it may be more efficient to use a single-pass miss curve construction algorithm. By leveraging methods that depend on the stack inclusion property, the entire miss curve can be computed efficiently for all cache sizes in a single pass, obviating the need to compute individual values for many discrete cache sizes. Other implementations for LRU caches may use an alternate MRC construction algorithm in place of SHARDS, such as Counter Stacks (see Wires, Jake, et al., “Characterizing Storage Workloads with Counter Stacks”, Proceedings of the 11th USENIX Conference on Operating Systems Design and Implementation (OSDI '14), Broomfield, Colo., October 2014) or ROUNDER (see Saemundsson, Trausti, et al., “Dynamic Performance Profiling of Cloud Caches”, Proceedings of the 2014 ACM Symposium on Cloud Computing (SOCC '14), Seattle, Wash., November 2014).

One advantage of the unified method for both monitoring and optimization according to embodiments of this invention is that it may be independent of the particular policy or replacement algorithm used by the cache; even very sophisticated or complex caching algorithms may be used. For example, one embodiment may use the unified method as the caching policy within each individual slice. In other words, the cache replacement policy employed within a single slice may itself be the unified method. In effect, this may be viewed as a nested (or meta-level, or recursive) use of the invention, where each slice is internally partitioned into nested slices, and an MRC local to each slice is computed and used to control the sizes of its constituent nested main slices. As with a non-nested embodiment, the MRC for a slice may be constructed using nested monitoring slices.

For online operation in a dynamic system, where the workload characteristics may change over time, careful consideration must be given to the timescale at which MRCs are constructed—an issue that was not addressed at all in the work on Talus. For example, if the MRC used to guide optimization is based on stale information, the optimization method may achieve sub-optimal results, or may even reduce performance over the baseline “unoptimized” system.

One option is to simply maintain a cumulative MRC that evolves over time as more cache requests are processed. However, once the historical information incorporated into the MRC becomes large, the MRC will be very slow to adapt to new workload behavior. Another approach is to periodically start a new MRC, such as by resetting its state after a fixed amount of time, or after processing a certain number of requests. A hybrid approach is to utilize multiple MRCs, created over different, overlapping intervals, allowing the optimization method to use and combine information collected at a hierarchy of timescales. This can be done efficiently by accumulating the data such as reuse-distance counts or hit- and miss-counts in a circular buffer where each entry in the circular buffer captures the data for a specific period of time. These data may then be combined to compute the MRCs or, more generally, CUCs, for different, possibly overlapping, time periods. As an added benefit, the values recorded in the circular buffer may be used to measure temporal changes, thereby enabling more adaptive approaches to triggering partition adjustment. Another alternative is to employ an explicit aging technique, such as by using an exponentially weighted moving average (EWMA) of the miss rates for each monitoring partition.

As a workload evolves over time, changes in its MRC (over some timescale) may necessitate dynamic changes to the efficient emulated cache sizes for the main slices, assuming main slices are implemented. A practical related issue is how to manage data cached earlier by one slice, which now belongs to a different slice due to changes in the portion of the hash value space covered by each. An approach that eagerly identifies and migrates such cached data between slices is likely to be inefficient. One alternative is a lazy approach that migrates such cached data only on hits.

Another practical issue is deciding when to initially invoke the optimization that determines the partition size for each main slice, as well as the portion of the input address space that it serves. One option is to start with just a single main slice, and to wait until the monitoring slices have processed enough requests to form a reasonably accurate MRC before splitting it into two (or more) main slices. Various embodiments may use different techniques to determine when the MRC has sufficient accuracy, such as waiting until a specified number of requests has been processed by each slice, a certain amount of time has elapsed, a particular fraction of each slice's initial contents have been evicted, the change of the MRC after a fixed number of requests is smaller than a threshold, or similar criteria. Note also that, in some cases, it may be efficient to retain only a single main slice.

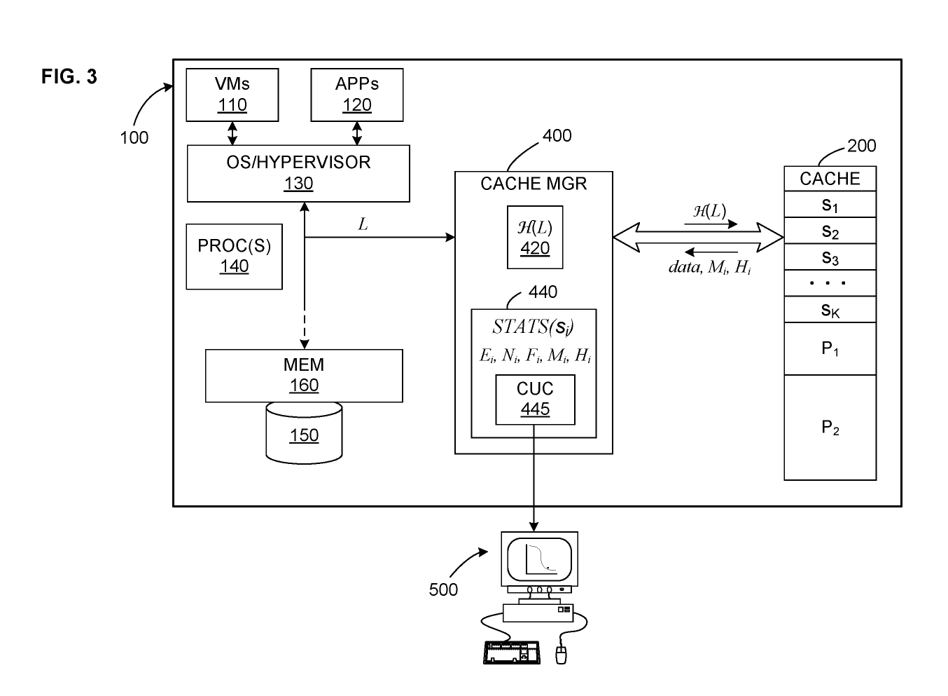

FIG. 3 illustrates a representative system 100 that implements an embodiment that is useful for compiling dynamic and even real-time, in-line analytic information useful for decisions regarding cache allocation. FIG. 3 shows various hardware and software components or “modules”. As is well know, such software modules comprise bodies of computer-executable code that may be stored, that is, embodied, in any conventional non-transitory medium, such as storage device(s) 150 and will usually be loaded into system memory 160 for execution by the system processor(s) 140. Indeed, some embodiments may be implemented at least in part as code running within the cache itself. Code defining one or more clients such as virtual machines 110 (viewed either individually, or in terms of a collective virtualization platform) and other applications 120 executes on the processor(s) 140 under the control of system software such as a hypervisor/operating system 130.

As is well known, the memory and storage access requests issued by workloads such as the VMs 110 and applications 120 typically will undergo one or more levels of redirection and will ultimately be mapped by the system software 130 to a stream of location identifiers Li used to address memory 160. The memory 160 and storage 150 are shown as being separate entities in FIG. 3, and within the same system 100, for the sake of ease of understanding. The distinction between memory and storage is becoming less and less, and is not necessary to this invention. For example, many “disk drives” nowadays are in fact not spinning media, but rather comprise solid-state devices (SSDs), including but not limited to flash drives, RAM-based storage systems, etc. Similarly, it is becoming more and more common for at least some memory and/or storage to be remote, for example, in external devices or in the “cloud”, and the invention may be used in such environments as well. The only assumption is that the system uses caching, regardless of where the memory/storage is located, how it is arranged, or what technologies it employs. Thus, from the perspective of the invention, location identifiers for “memory” or “storage” are identical, such that reference to one should not here be read as a limitation excluding the other.

The clients are any entities that address the storage/memory system 150/160 either directly or, more likely, via one or more intermediate address translations. Although the clients (such as the VMs 110 and applications 120) are shown as being within the system 100, embodiments of the invention can also accommodate remote clients, such as applications being run from the cloud. The clients may also be hardware entities that issue memory/storage access requests, typically from some form of controlling software such as a driver. Depending on the chosen implementation, the clients may communicate data requests to one or more cooperating servers via a bus, a network, or any other communications channel. Merely for the sake of simplicity of explanation, the clients in this example are shown as being incorporated into the system 100 itself, in which case no network will normally be needed for them other than internal buses.

The system also includes at least one cache 200, which is accessed and controlled by a cache manager 400. In some systems, a single cache serves all of the clients (VMs, applications, etc.) whereas, in other systems, multiple caches are included for any of a variety of reasons. In multi-cache systems, the invention may be used for each independently. In the example shown in FIG. 3, the cache has been logically divided to include two main partitions P₁, P₂, such as, as just one example, the two main slices according to a Talus system. Recall, however, that the embodiments of the invention do not require such “operational partitioning” at all. Moreover, as described below, cache partitioning further includes the monitoring slices.

As FIG. 3 shows, a portion of the cache is designated for monitoring, and is shown as having been logically partitioned into monitoring slices S₁, S₂, . . . , S_{K}. The figure does not show these “to scale”—the monitoring slices may be orders of magnitude smaller than the rest of the cache, for example, the main slices. Also, the figures show the monitoring slices as being contiguous within the cache. This is for ease of visualization and description and is not necessary; as one alternative, the monitoring slices could be distributed more or less evenly across the cache.

Moreover, even though the monitoring slices appear to be of equal size in FIG. 3, this is also merely for the sake of illustration. As described above, this may be the chosen arrangement, but they may also have different sizes. Even so, recall that even if a monitoring slice Sᵢ takes up the same amount of the cache as another monitoring slice Sⱼ, this does not necessarily mean that they have the same emulated cache size, since they may handle different fractions of the input address space. Cache size emulation thus uses a form of relative size “normalization” that allows for useful information to be derived for numerically relatively large cache partitions even using numerically relatively small ones. Note that the emulated size of a large cache partition such as, usually, a main slice P₁, P₂, is not necessarily larger than the emulated cache size of a relatively small slice such as a monitoring slice.

In the illustrated example, one of the virtual machines 110 has issued a read request for data at location L. (For simplicity and clarity, any intermediate address translations are ignored here.) A module 420 may then compute a hash [symbol] (L) of the location identifier L. If hash computation is not already implemented in hardware, then it may be included as a code module, for example, within the cache manager, or accessible to it.

As mentioned above, each main slice (if implemented, such as in Talus) is responsible for caching data in a partition associated with a different subset of the input address space. Both main and monitoring slices however, are also associated with respective subsets of the space of hash values [symbol] (Li). Each monitoring slice may then be treated as a “mini-cache” to which spatial sampling may be applied. “The” cache 200 therefore functions, in effect, as a collection of separate, per-slice caches that operate substantially independently. [symbol] (L) thus maps to a slice, which may then use any known indexing method to look up the entry L, such as simply using low-order address bits, or even by using another hash function. In a software-managed storage cache, it would therefore be possible to instantiate multiple separate cache instances, each with its own private metadata state. For example, multiple slices could each run ARC independently, each with its own ARC state/metadata (T1, T2, B1, B2 lists, etc.).

Assume that the range of possible [symbol] (Li) values extends from [symbol] ₘᵢₙ to [symbol] ₘₐₓ. A subset of this hash space is then associated with each main slice, as well as for each of the K monitoring slices S₁, S₂, . . . S_{K}. For example, [symbol] (Li) values that fall in the sub-ranges [symbol] ₁=[ [symbol] ₁ₘᵢₙ, [symbol] ₁ₘₐₓ) may be associated with S₁; [symbol] (Li)ε [symbol] ₂=[ [symbol] ₂ₘᵢₙ, [symbol] ₂ₘₐₓ); is associated with S₂; . . . , [symbol] (Li)ε [symbol] ⱼ=[ [symbol] ⱼₘᵢₙ, [symbol] ⱼₘₐₓ); is associated with Sⱼ, and so on. Hash ranges [ [symbol] _{P1min}, [symbol] _{P1max}] and [ [symbol] _{P2min}, [symbol] _{P2max}] are associated with the main slices P₁ and P₂, respectively. In short, every value [symbol] (Li) is mapped to an element in exactly one of the slices, either a main slice or a monitoring slice. As mentioned above, these ranges need not comprise contiguous values, although this will in many cases be the most easily administered choice. Alternative partitioning could, for example, use bit patterns. Note that, due to the nature of the most common hash functions, even if a sequence of location identifiers L happens to be consecutive, their hashed values almost certainly will not be.

The data concerning hits Hᵢ and misses Mᵢ for each slice may be obtained in any known manner. For example, a software-managed cache (e.g., memory cache of disk blocks) already typically tracks such basic statistics like the number of accesses and misses. Even most hardware-managed caches (e.g., processor one-die LLC) also typically maintain hardware performance counters for accesses and misses, and expose these to software. Moreover, although software usually can't be in the critical path of cache access in a hardware-managed cache, hardware may keep free-running counters that can be polled by software (or configured to generate an interrupt after a programmable number of events). Hardware processor cache partitioning is also known in the literature, and is becoming more commercially available over the past few years. When hardware counters in such architectures become commercially available on a per-partition basis, they may also be used to provide the per-slice hit/miss data used to create CUCs as described here. The hit/miss statistics for each slice can thus be accumulated and, when desired, reset, for example, by a statistics module 440, either during a chosen time period, or after a certain number of cache accesses, or both, or according to any other chosen cut-off condition is met.

The inventors have discovered that surprisingly accurate MRCs can be constructed using the miss/hit statistics of only the monitoring slices, which, as mentioned above, may take up as little as 1% of the available cache space, in almost all typical cases, no more than 10%, and, in some cases, even less than 1%. In other words, even if the hit/miss statistics are not determined for the main slices, accurate MRCs can still be determined. Nonetheless, it is also possible to compile and use in CUC construction the hit/miss statistics even for one or more of the main slices.

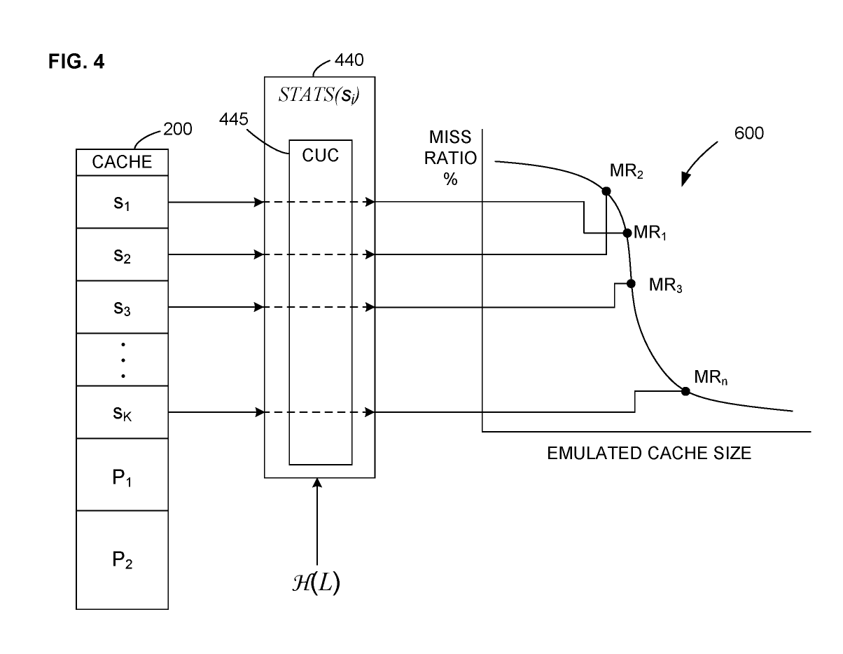

The results of the hit/miss testing per slice are made available to a cache utility curve (CUC, such as an MRC or HRC) compilation module 445, which may determine the emulated cache size Eᵢ represented by each monitoring slice Sᵢ, given the parameters Nᵢ and Fᵢ, and the cache utility value (such as miss rate), given the accumulated values Mᵢ and Hᵢ. The module 445 may thus determine a miss ratio for the emulated cache size for each monitoring or main slice, which corresponds to a point on a miss rate curve. This is illustrated in FIG. 4, in which MRC 600 points MRᵢ are shown as having been derived from the miss statistics of respective monitoring slices Sᵢ. Although not illustrated here, it would also be possible to determine cache utility values, and thus points on the MRC, for the main slices as well although.

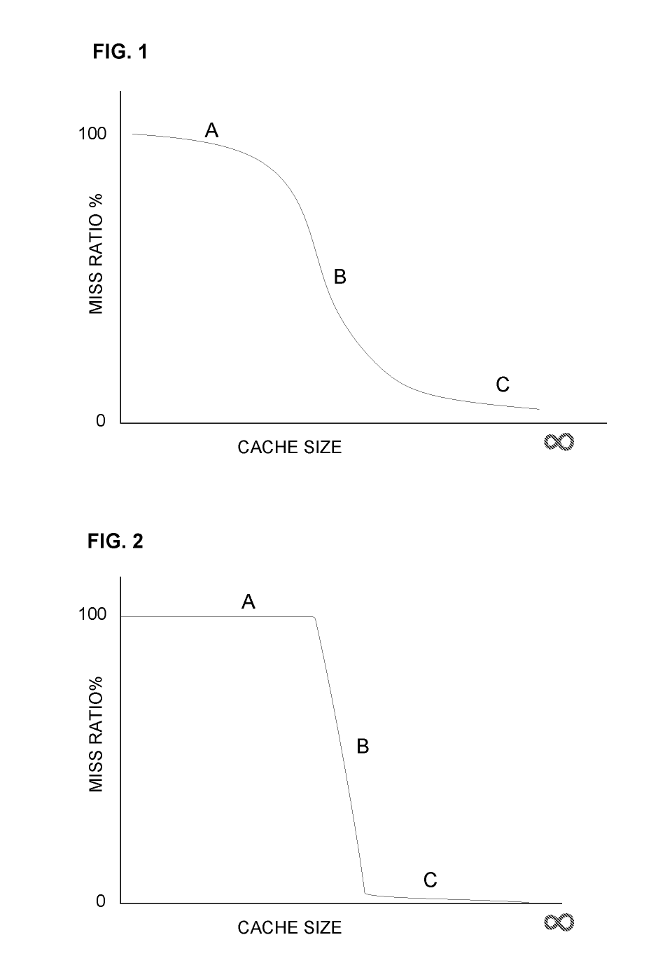

Assuming a suitable distribution of emulated cache sizes for the monitoring slices, enough points will be generated to represent an MRC for the region of interest. In some cases, the purpose of this will be to find, via emulation, the cache size for which the miss rate is in the “B” range (see FIGS. 1 and 2). In other cases, the goal will be to examine the effects of a change in cache partitioning from a current choice. In still other cases, the MRC may inform decisions about whether additional cache is needed. Note that embodiments of the invention make it possible to construct such a CUC in real time, analyzing the actual working cache, even (but not necessarily) in conjunction with a cache allocation system that itself logically partitions the cache.

If external evaluation, for example, by an administrator, is desired, the MRC results may then be passed to a workstation monitor 500, which can then display the current CUC estimate. The monitor 500 may also be included to allow a system administrator to communicate various parameters to the cache manager, which then may then adjust, either under operator control or automatically, the current cache partitions or so as to improve the cache performance.

The frequency with which the system determines a slice-based CUC may be varied and chosen according to any schedule, or heuristically, or based on any chosen system conditions. For example, too frequent changing of cache partitions may cause more problems than it solves. Thus, per-slice hit/miss/etc. statistics are preferably not consulted on a per-request basis, but rather periodically, to inform optimization, for example, after a coarse-grained re-partitioning “epoch” likely consisting of thousands or millions of individual requests.

The various software modules that are included in the cache manager 400, may, but need not, be implemented as separate bodies of computer-executable code; thus, any or even all of these modules could be implemented as a unified program that could be installed either along with the other system software, or later. As another option, in some implementations the statistics module 440 could be implemented as a separate module that communicates with but is not itself part of the cache manager 400 itself, as long as it has access to or receives the per-slice miss/hit statistics. Furthermore, any or all of software modules could instead be implemented in hardware; for example, hash computation is often included within existing hardware processor caches, and could be used to implement the module 420.

1. A method for evaluating interaction between a cache in a computer system and at least one entity, the at least one entity submitting a stream of location identifiers corresponding to references to data storage locations, said computer system including a processor, the method comprising:
configuring within the cache a plurality of monitoring slices, each monitoring slice comprising a separately addressable partition of the cache;
associating a respective sub-range of a hash function with each of the monitoring slices, said hash function having a range that includes at least the addressable partitions of the cache that comprise the monitoring slices;
for each of the location identifiers computing a respective location identifier hash value as the output of the hash function and determining in which, if any, monitoring slice-associated hash function sub-range the location identifier hash value falls;
for at least one of the monitoring slices, determining a frequency value as a function of how many of the location identifier hash values fell into the slice's associated hash function sub-range; and
computing a respective cache utility value as a function of each monitoring slice's frequency value.

2. The method as in claim 1, further comprising adjusting allocation of the cache as a function of the cache utility values.

3. The method as in claim 1, in which the cache is an operational system cache, said monitoring slices thereby processing actual cache requests.

4. The method as in claim 1, in which the data storage locations include locations in a system memory of the computer system.

5. The method as in claim 1, further comprising:
configuring a plurality of the monitoring slices to have different emulated cache sizes; and
compiling the cache utility values of the different monitoring slices to represent a cache utility curve.

6. The method as in claim 5, comprising configuring the plurality of the monitoring slices to have different emulated cache sizes by choosing them to differ with respect to at least one of a number of cache blocks they include and a fraction of an input address space they are associated with.

7. The method as in claim 5, further comprising:
periodically resetting and restarting the determination of the frequency values for the monitoring slices and compiling the cache utility values for each of a plurality of periods; and
adjusting cache partitioning over time as a function of the cache utility values at the plurality of periods.

8. The method as in claim 5, further comprising:
periodically resetting and restarting the determination of the frequency values for the monitoring slices and compiling the cache utility values for each of a plurality of periods; and
adjusting cache partitioning over time as a weighted moving average of the cache utility values at the plurality of periods.

9. The method as in claim 5, further comprising dynamically changing a configuration of at least one of the monitoring slices.

10. The method as in claim 9, in which the configuration change is a change of the number of the monitoring slices.

11. The method as in claim 9, in which the configuration change is a change of the emulated sizes of the monitoring slices.

12. The method as in claim 1, further comprising applying different cache replacement policies to at least two of the monitoring slices.

13. The method as in claim 1, further comprising configuring within the cache at least one main slice occupying a partition of the cache separately addressable and distinct from the monitoring slices, each said main slice being associated with a respective hash function sub-range distinct from the hash function sub-ranges of the monitoring slices and of other main slices, the set of hash function sub-ranges of the monitoring slices and the main slices spanning the entire hash function range.

14. The method as in claim 13, comprising configuring a plurality of main slices within the cache.

15. The method as in claim 14, further comprising adjusting cache allocation of the main slices as a function of the cache utility values of the monitoring slices.

16. The method as in claim 14, further comprising adjusting changing the hash function sub-ranges associated with the main slices as a function of the cache utility values of the monitoring slices.

17. The method as in claim 15, comprising adjusting cache allocation of the main slices as a function of the cache utility values of only the monitoring slices.

18. The method as in claim 15, further comprising determining a main slice frequency value for at least one of the main slices as the function of how many of the location identifier hash values fell into the main slice's associated hash function sub-range; and
computing a main slice respective cache utility value as a function of each main slice's frequency value.

19. The method as in claim 14, further comprising dynamically configuring at least one of the main slices to use a different cache replacement policy according to the cache utility values.

20. The method as in claim 13, further comprising configuring the monitoring slices to occupy no more than 10% of the cache.

21. The method as in claim 20, further comprising configuring the monitoring slices to occupy no more than 1% of the cache.

22. The method of claim 1, further comprising configuring the monitoring slices as independent cache instances having their own separate, respective metadata and state.

23. A system for evaluating interaction between a cache in a computer system and at least one entity, the at least one entity submitting a stream of location identifiers corresponding to references to data storage locations, said computer system including a processor, the system comprising:
a plurality of monitoring slices configured within the cache, each monitoring slice comprising a separately addressable partition of the cache, each monitoring slice further being associated with a respective sub-range of a hash function, said hash function having a range that includes at least the addressable partitions of the cache that comprise the monitoring slices;
a cache management sub-system provided to compute, for each of the location identifiers, a respective location identifier hash value as the output of the hash function and to determine in which, if any, monitoring slice-associated hash function sub-range the location identifier hash value falls;
for at least one of the monitoring slices, means for determining a frequency value as a function of how many of the location identifier hash values fell into the slice's associated hash function sub-range, and for computing a respective cache utility value as a function of each monitoring slice's frequency value.

24. The system as in claim 23, in which the cache management sub-system is further provided for adjusting allocation of the cache as a function of the cache utility values.

25. The system as in claim 23, in which the cache is an operational system cache, said monitoring slices thereby processing actual cache requests.

26. The system as in claim 23, in which the data storage locations include locations in a system memory of the computer system.

27. The system as in claim 23, in which the cache management sub-system is further provided for configuring a plurality of the monitoring slices to have different emulated cache sizes; and for compiling the cache utility values of the different monitoring slices to represent a cache utility curve.

28. The system as in claim 27, in which the plurality of the monitoring slices are configured to have different emulated cache sizes, chosen to differ with respect to at least one of a number of cache blocks they include and a fraction of an input address space they are associated with.

29. The system as in claim 27, in which the cache management sub-system is further provided for:
periodically resetting and restarting the determination of the frequency values for the monitoring slices and compiling the cache utility values for each of a plurality of periods; and
adjusting cache partitioning over time as a function of the cache utility values at the plurality of periods.

30. The system as in claim 27, in which the cache management sub-system is further provided for:
periodically resetting and restarting the determination of the frequency values for the monitoring slices and compiling the cache utility values for each of a plurality of periods; and
adjusting cache partitioning over time as a weighted moving average of the cache utility values at the plurality of periods.

31. The system as in claim 27, in which the cache management sub-system is further provided for dynamically changing a configuration of at least one of the monitoring slices.

32. The system as in claim 31, in which the configuration change is a change of the number of the monitoring slices.

33. The system as in claim 31, in which the configuration change is a change of the emulated sizes of the monitoring slices.

34. The system as in claim 23, in which further different cache replacement policies are applied to at least two of the monitoring slices.

35. The system as in claim 23, further comprising at least one main slice occupying a partition of the cache separately addressable and distinct from the monitoring slices, each said main slice being associated with a respective hash function sub-range distinct from the hash function sub-ranges of the monitoring slices and of other main slices, the set of hash function sub-ranges of the monitoring slices and the main slices spanning the entire hash function range.

36. The system as in claim 35, including a plurality of the main slices within the cache.

37. The system as in claim 36, in which the cache management sub-system is further provided for adjusting cache allocation of the main slices as a function of the cache utility values of the monitoring slices.

38. The system as in claim 36, in which the cache management sub-system is further provided for adjusting changing the hash function sub-ranges associated with the main slices as a function of the cache utility values of the monitoring slices.

39. The system as in claim 37, in which cache allocation of the main slices is adjusted as a function of the cache utility values of only the monitoring slices.

40. The system as in claim 37, in which the cache management sub-system is further provided for determining a main slice frequency value for at least one of the main slices as the function of how many of the location identifier hash values fell into the main slice's associated hash function sub-range; and for computing a main slice respective cache utility value as a function of each main slice's frequency value.

41. The system as in claim 36, in which the cache management sub-system is further provided for dynamically configuring at least one of the main slices to use a different cache replacement policy according to the cache utility values.

42. The system as in claim 35, in which the monitoring slices occupy no more than 10% of the cache.

43. The system as in claim 42, in which the monitoring slices occupy no more than 1% of the cache.

44. The system of claim 23, in which the monitoring slices are independent cache instances having their own separate, respective metadata and state.
